(19) United States
(12) Patent Application Publication
(10) Pub. No.: US 2017/0334665 A1
(43) Pub. Date: Nov. 23, 2017

(54) CONTAINER STOP MECHANISM AND METHOD FOR CONTROLLED BRAKING, STOPPING, AND SEPARATING OF CONTAINERS, SUCH AS GLASS BEVERAGE BOTTLES

(71) Applicant: Andreas FAHLDIECK, Idar-Oberstein (DE)

(72) Inventor: Andreas FAHLDIECK, Idar-Oberstein (DE)

(21) Appl. No.: 15/617,281

(22) Filed: Jun. 8, 2017

Related U.S. Application Data
(63) Continuation-in-part of application No. PCT/EP2015/078746, filed on Dec. 7, 2015.

(30) Foreign Application Priority Data
Dec. 10, 2014 (DE) 102014118264.2

(51) Int. Cl. B65G 47/88; B65G 47/29; B65G 47/08

(52) U.S. Cl. CPC B65G 47/8823; B65G 47/082; B65G 47/29

(57) ABSTRACT

A container stop mechanism and method for controlled braking, stopping, and separating of containers, such as glass beverage bottles. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2015/078746, filed on Dec. 7, 2015, which claims priority from Federal Republic of Germany Patent Application No. 10 2014 118 264.2, filed on Dec. 10, 2014. International Patent Application No. PCT/EP2015/078746 was pending as of the filing date of this application. The United States was an elected state in International Patent Application No. PCT/EP2015/078746.

### BACKGROUND

### 1. Technical Field

The present application relates to a container stop mechanism and method for controlled braking, stopping, and separating of containers, such as glass beverage bottles.

### 2. Background Information

Background information is for informational purposes only and does not necessarily admit that subsequently mentioned information and publications are prior art.

The present application relates to a container stop mechanism for controlled braking and/or stopping and/or separating of at least one container in a container flow moving in a transport direction on a container transport path according to the present application, and to a method for controlled braking and/or stopping and/or separating of at least one container in a container flow moving in a transport direction on a container transport path according to the present application.

In many cases it is necessary and/or may be desired, in systems for processing or treating containers, for example also in systems in the beverage industry, for the container flow being conveyed on a transporter of a container transport path to be braked or decelerated and/or to be stopped, and/or for gaps to be formed in the container flow, i.e. for a part of a container flow moving ahead in the flow in the transport direction of the transporter to be separated from a part of the container flow following behind. In order in this situation to avoid, restrict, and/or minimize an excessive amount of noise being incurred, and for example also to avoid, restrict, and/or minimize damage to the containers, it is desirable for the braking and/or stopping of the container flow not to take place abruptly, but instead dynamically or in decelerated manner, i.e. with reduction of the speed of the part following in the container flow or following a gap in relation to the transport speed of the container transport path or of the transporter at that location.

In other words, for example, it is common in the container handling or beverage bottling industry to transport containers or bottles in a line one after the other. In this situation, the containers are very close together or touching. In the case of glass containers, for example, it is desirable to minimize or prevent impacts between adjacent glass containers to thereby minimize or prevent breakage or damage to the glass containers, as well as to minimize noise created by the impact of glass on glass. However, it is often necessary to block or stop or interrupt the movement or transport of a portion of the line of glass containers. This may be done in order to create spacing between individual glass containers or groups of glass containers. It may also be done in the event that one or more container handling machines downstream of the glass containers need to be shut down for some reason. The difficulty is that when the glass containers are stopped, the succeeding glass containers impact the adjacent glass containers ahead of them in the line of glass containers. If the stoppage is abrupt or sudden, the impact between glass containers could be substantial, possibly to the point that the impact results in damage to or breakage of the glass containers. According to the present application, instead of executing an abrupt or sudden stoppage of the line of glass containers or a portion of the line of glass containers, a gradual deceleration or braking could be performed. In this manner, damage and noise due to impact between adjacent glass containers could be substantially decreased, minimized, or prevented.

Some container transport paths may have container stop mechanisms, which are arranged at a side of the container transport path or of the transporter of this transport path. These stop mechanisms essentially comprise a slide which can be moved, controlled by a pneumatic cylinder, between an initial position and an end position. Mounted on the slide so as to rotate about a vertical axis, as a container blocking element, is a blocking star. The blocking star comprises a plurality of container pockets that are open on the circumference side of the blocking star. In each case, one of the pockets extends into the movement path of the containers being transported on the transporter. During normal operation, the blocking star is freely rotatable, such that the containers can be moved past the rotating blocking star. When a container stop is initiated, the blocking star is blocked by a blocking cylinder provided on the slide, such that the containers being conveyed are held back by the blocking star. In this situation, the blocking star and the carriage move at a reduced speed, braked by the pneumatic cylinder, such that a dynamic and gentle braking and/or stopping of the conveyed container flow is achieved. Disadvantageous, however, among other factors, is the fact that a flexible supply line is required and/or desired for the blocking cylinder, and, moreover, that the blocking star exhibits a substantial mass, which, at the blocking of the container flow is accelerated abruptly, which, among other factors, impedes the gentle braking and/or stopping which is intended.

### Object or Objects

An object of the present application may be to provide a container stop mechanism which, while having high operational reliability, comprises a simplified structural design. To solve this object, a container stop mechanism is provided in accordance with the present application. A method for the controlled braking and/or stopping and/or separating of at least one container in a container flow moving in a transport direction on a container transport path may also be an object of the present application.

### SUMMARY

One aspect according to the container stop mechanism comprises the fact that the at least one stopping arrangement and the first and second drive unit are provided on a jib extending along the container transport path. The jib is configured so as to be pivotable around a vertical or substantially vertical axis between the initial position and the stop position by the second drive unit. The container stop mechanism according to the present application may therefore, due to the provision of the jib, have a simple design solution for the movement of the stopping arrangement from the initial position into the stop position. Consequently, a very rapid and highly precise or essentially precise engagement into the container flow is possible by way of the at least one stopping arrangement.

In at least one possible exemplification, the jib comprises a lever region interacting with a lever arrangement, as well as at least one acceleration path for the acceleration region comprising the stopping arrangement.

In at least one possible exemplification, the first drive unit is configured in such a way that it accelerates the stopping arrangement out of the initial position of the jib, initially along the acceleration path in the transport direction, before, with the jib in the stop position, it moves the stopping arrangement at a speed which is at least reduced in comparison with the transport speed of a transporter.

According to one exemplification, the second drive unit is assigned with a first end to the lever arrangement and with a second end to the jib, in such a way that the jib can be pivoted around the vertical or substantially vertical axis between the initial position and the stop position by the second drive unit.

In at least one possible exemplification, the first drive unit and/or the second drive unit can be configured as linear drives, in one possible exemplification as pneumatic cylinder devices.

In at least one possible exemplification, the pivotable jib is configured in the initial position at least with its acceleration region essentially parallel to the container transport path. In this situation, the lever region and the acceleration region of the jib can be configured along a longitudinal axis as oriented towards each other.

According to a further exemplification, the acceleration path of the jib can comprise at the end assigned to the lever region at least one first stop, and, at the end facing away from the lever region, at least one second stop.

According to a further exemplification, the acceleration path can be configured as a slide guide, which comprises at least one guide rod, oriented parallel or substantially parallel to the longitudinal axis, along which can be moved a stopping arrangement configured as a slide.

The first drive unit may be configured as a spindle drive with at least one electric motor, by which at least one spindle rod can be set in rotation. The spindle rod in turn interacts with at least one spindle nut that is connected to or forms part of the stopping arrangement, which is configured as a slide, such that the stopping arrangement can therefore be moved in both directions along the slide guide by the rotation of the at least one spindle rod, as a function of the rotation of the electric motor. In this situation, the electric motor can possibly be configured as a servomotor or asynchronous motor.

According to a further exemplification, the slide can comprise a guide mechanism, which in turn comprises at least one slide guide rod, provided parallel or substantially parallel to the at least one guide rod, as well as at least one guide element capable of moving along the slide guide.

In at least one possible exemplification, a damping device can be assigned to the guide device. In one possible exemplification, the damping device can comprise at least a plurality of magnets which are freely displaceable along the slide guide rod, configured as permanent magnets or also as electromagnets. Further, the plurality of magnets can be arranged in such a way at the slide guide rod that in each case mutually repelling north poles and south poles respectively of the corresponding adjacent magnets lie at least partially opposite one another. Further still, the plurality of magnets can exhibit an approximately identical field strength. If the freely displaceable magnets are electromagnets, then the respective magnetic force can be changed by suitable controlling or regulating, such that the magnetic force and/or the dynamic behavior of the arrangement can be adjusted in a simple manner to changing requirements.

According to another alternative exemplification, the first and second stops can be constituent parts of the slide guide, and form the face-side closure elements for the holding of the at least one guide rod.

Additionally, provision may be made for the acceleration region and the lever region of the jib to be oriented by ninety degrees to one another.

According to a further aspect, the present application relates to a method for the controlled braking and/or stopping and/or separating of at least one container in a container flow moving in a transport direction on a container transport path, wherein a jib, extending along the container transport path, on which at least one stopping arrangement as well as the first and second drive units are provided, is pivoted by the second drive unit around a vertical or substantially vertical axis between the initial position and the stop position.

“Containers” in the meaning of the present application are, in one possible exemplification, cans, bottles, drums, also kegs, tubes, and pouches, in each case made of metal, glass, and/or plastic, but also other packaging structures or devices, including also such as are suitable for the filling of powder-form, granulate-type, fluid, or viscous products.

The expressions “essentially” or “approximately” or “approx.” signify in the meaning of the present application deviations from the respective exact value by +/−10%, in one possible exemplification by +/−5%, and/or deviations in the form of modifications which are not of significance for the function.

Further exemplifications, advantages, and possible applications of the present application are also derived from the following description of exemplifications and from the figures. In this context, the features described and/or pictorially represented are in principle the object of the present application, individually or in any desired combination, regardless of their summary or reference to them. The contents of the claims also form a constituent part of the description.

The above-discussed exemplifications of the present invention will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is described in greater detail hereinafter on the basis of the figures in respect of exemplifications. The figures show:

FIG. 1 in schematic representation and in a view from above, a container transport path with a first exemplification variant of a container stop mechanism according to the present application;

FIGS. 2-5 in each case in a schematic representation and view from above, the container transport path from FIG. 1, with a first exemplification variant of the container stop mechanism according to the present application, in different operational states;

FIG. 6 a further exemplification variant of a container stop mechanism according to the present application, in a schematic perspective representation;

FIG. 7 another further exemplification variant of a container stop mechanism according to the present application, in a schematic view from above;

FIG. 8 a schematic principle sketch of the kinematic adhesion of a container stop mechanism according to FIG. 7;

FIG. 9 another further exemplification variant of a container stop mechanism according to the present application, in a schematic view from above; and

FIG. 10 another further exemplification variant of a container stop mechanism according to the present application, in a schematic view from above.

### DESCRIPTION OF EXEMPLIFICATION OR EXEMPLIFICATIONS

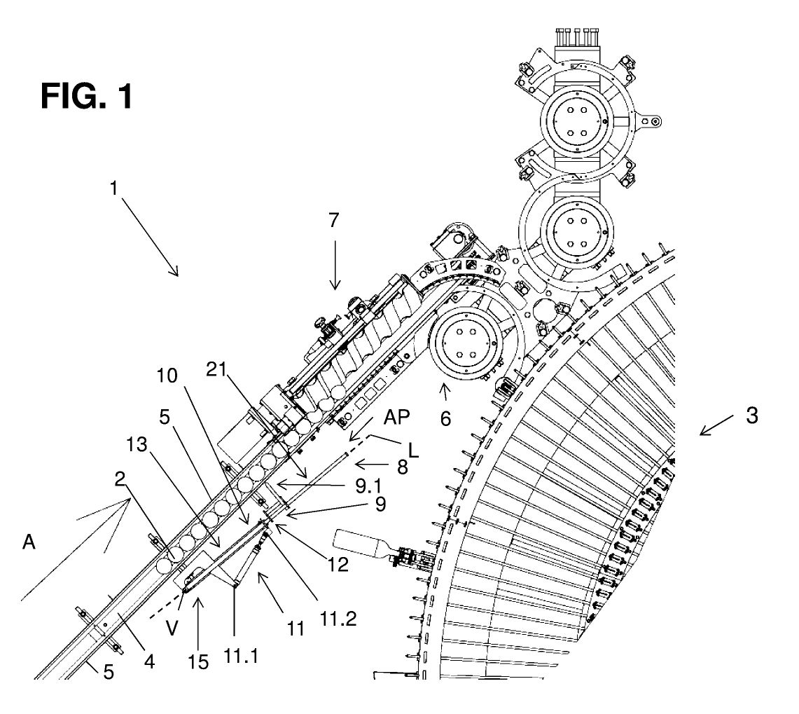

The container transport path 1 is designated in general in FIGS. 1-7 and is configured in the exemplification variant represented as a linear conveying path, and serves, for example, to convey the containers 2 in a densely packed, in one possible exemplification single-track container flow, in which the containers 2 follow directly one after another in a transport direction A, a container handling machine 3, following on the container transport path 1 in the transport direction A, which can be configured, for example, as a rinser.

The container transport path 1 comprises, among other elements, a transporter 4 in the form of at least one transport band, for example, in the form of a slatband chain, on which the containers 2 stand upright on their container bases, oriented with their container axes oriented in the vertical direction or essentially in the vertical direction. The transporter 4 also includes two guide rails 5 for the containers 2, delimiting the sides of the container transport path. Related to the transport direction A, before the end of the container transport path 1, on which a container intake facility 6 follows upstream of the container handling machine 3, a container separating element 7 is provided on one side of the container transport path 1, with which container separating element 7 the containers 2 following one another in the container flow are brought into a spacing interval from one another, which corresponds to a separation spacing interval of the downstream container handling machine 3, and which, in the exemplification represented, is configured as a separation worm element.

Related to the transport direction A, upstream of the container separating element 7, a container stop mechanism 8 is further provided on the container transport path 1, with which, when the necessity arises, the feed of the containers 2 to the downstream container handling machine 3, and, in the exemplification shown, to the container separating element 7, can be interrupted in a controlled and/or regulated manner, and/or gaps can be created in the container flow being fed to the container separation element 7. With the exemplification variant represented, the container stop mechanism 8 is located on the longitudinal side of the container transport path 1 or of the transporter 4 respectively, opposite the container separation element 7.

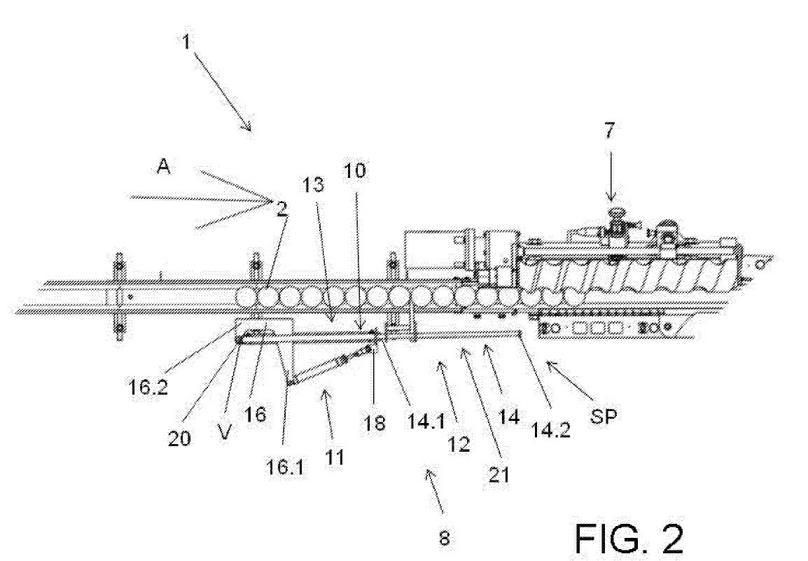

The container stop mechanism 8 comprises in this situation at least one stopping arrangement or device 9 for the at least partial engagement into the container flow, as well as a first drive unit 10, indicated schematically in FIGS. 1 to 5, by which the stopping arrangement 9 can be driven along the container transport path 1 in and/or against the transport direction A, in a controlled manner by a control device (not shown). The container stop mechanism 8 according to the present application further comprises at least one second drive unit 11, by which the stopping arrangement 9 can be moved between an initial position AP, shown in FIG. 1, not engaging into the container flow, and a stop position SP, shown in FIGS. 2 to 4, engaging into the container flow, in a controlled manner by a control device (not shown). According to the present application, in this situation the at least one stopping arrangement 9 and the first and second drive units 10 and 11 are provided on a jib 12, extending along the container transport path 1, which is configured such as to be pivoted by the second drive unit 11 around a vertical or substantially vertical axis V between the initial position AP and the stop position SP.

Moreover, the jib 12, shown in FIGS. 1 to 5, which can be pivoted around a vertical or substantially vertical axis V, can comprise a lever region 13 and an acceleration region 21 with at least one acceleration path 14, which in one possible exemplification can be provided along a longitudinal axis L of the jib 12, oriented towards one another on this axis. The lever region 13 of the jib 12 can in this situation interact with a lever arrangement 15, to which can be assigned at least one lever element 16, with a rotation axis 20, for pivoting the entire jib 12 around the vertical axis V, as well as the second drive unit 11, such that, in the final analysis the entire jib 12 is configured so as to pivot, by the lever arrangement 15, between the initial position AP and the stop position SP around the rotation axis 20 or vertical axis V respectively.

In the exemplification variant shown in FIGS. 1 to 5, the lever element 16 is configured as U-shaped, and comprises a first limb 16.1 and a second limb 16.2, shorter in relation to the first, by which the container stop mechanism 8 can be arranged at the transport path 1. In this situation, the rotation axis 20 for the rotational movement of the jib 12 in the pivot range can be provided in the face-side end region of the shorter second limb 16.2, and at the first limb 16.1 a first end 11.1 of the second drive unit 11 can likewise be arranged such as to rotate. In this situation, there extends from the rotation axis 20, essentially along the longitudinal axis L of the jib 12, first the lever region 13 and then the acceleration region 21 with the acceleration path 14, which in the exemplification variant in FIGS. 1 to 5 is a part of the jib 12, and is therefore arranged at the jib 12. The jib 12 can also comprise, in the region of the transition from its lever region 13 to the acceleration path 14, a holding element 18 for a rotationally movable reception mounting of a second end 11.2 of the second drive unit 11, such that the second drive unit 11 can thereby be finally secured between the holding element 18 and the first limb 16.1, and with rotational movement.

The stopping arrangement 9 can, for example, be arranged in the form of a slide, and can therefore be arranged so as to move longitudinally at the jib 12, in one possible exemplification at the acceleration path 14 of the jib 12. The stopping arrangement 9 can, in one possible exemplification, comprise an engagement section 9.1, which is configured such as to engage at least partially into the container flow. In one possible exemplification, the engagement section 9.1 can be configured as sword-shaped, for example as a stopper wedge, and in one possible exemplification extends oriented at right angles away from the jib 12, i.e. orthogonally to the longitudinal axis L. The engagement section 9.1 can in this situation be detachably connected to the stopping arrangement 9, or, as an alternative, be configured as of one piece with the stopping arrangement 9. For example, for the purpose of the detachable connection to the stopping arrangement, the engagement section 9.1 can comprise a groove, not shown, into which a bolt can be introduced, which is held by bolt receptacles to the stopping arrangement 9.

For example, the second drive unit 11 can be a linear drive, In one possible exemplification a pneumatic cylinder device capable of being moved in and out. The linear drive is in the stationary state of FIG. 1, showing the initial position AP of the container stop mechanism 8, is configured as moved in, while the pneumatic cylinder device for the stop position SP of FIGS. 2 to 4 can be moved out by a controllable path distance.

Moreover, the first drive unit 10, which in FIGS. 1 to 5 is indicated schematically, can also be a linear drive, in one possible exemplification a pneumatic cylinder device capable of being moved in and out, wherein this too, in the stationary state of FIG. 1, showing the initial position AP of the container stop mechanism 8, can be configured as moved in, and for the stop position SP of FIGS. 2 to 4, is moved out by a controllable path distance. In this situation, the first drive unit 10, in one possible exemplification, interacts with the stopping arrangement 9 along the acceleration path 14 in such a way that the first drive unit 10, in the manner described in greater detail hereinafter, during the movement of the stopping arrangement 9 along the acceleration path 14 in the transport direction A, i.e. from the initial position AP to the stop position SP, first has the effect of accelerating the stopping arrangement 9, and then has the effect of braking the stopping arrangement 9, in relation to the container flow being conveyed by the transporter 4. By use of the first drive unit 10, the stopping arrangement 9 can be moved back along the acceleration path 14, i.e. against the transport direction A, out of the stop position SP, in which the stopping arrangement 9 has moved to the end of the acceleration path 14 opposite the lever region 13, back to the initial position AP, i.e. to the end of the acceleration path 14 assigned to the lever region 13.

For this purpose, the acceleration path 14 can comprise at the end of the jib 12, assigned to the lever region 13, at least one first stop 14.1, and, at the end facing away from the lever region 13, at least one second stop 14.2, wherein the stop arrangement 9, with the first drive unit 10, is in one possible exemplification configured such as to be completely movable between the two stops 14.1 and 14.2. Further, the acceleration path 14 is dimensioned in its longitudinal extension along the longitudinal axis L in such a way that it in one possible exemplification reaches as far as the intake of the container separating element 7, lying in the transport direction A, but the containers 2 on the transporter no longer pass into the area of effect of the container separating element 7. In this situation, in one possible exemplification, the holding element 18 also forms the first stop 14.1.

FIG. 1 shows the container transport path 1 in an operational state in which the containers 2 form an uninterrupted container flow along the entire container transport path 1 in the transport direction A. The container stop mechanism 8 in this situation is in its initial position AP, in which the stopping arrangement 9 are in one possible exemplification in contact at the first stop 14.1 of the acceleration path 14, and the jib 12 is deflected in such a way that the stopping arrangement 9 does not engage into the container flow of the transport path 1, and, as a result, the container stop mechanism 8 is held in a non-effective position.

If it is now intended, for the interruption of the container flow, a stop position SP of the container stop mechanism 8 is adopted, the stopping arrangement 9 is moved with the first drive unit 10 along the acceleration path 14, and therefore along the transport path 1 in the transport direction A, in such a way that the stopping arrangement 9 first comes free from the first stop 14.1, and in one possible exemplification is accelerated to, or approximately to, the speed of the transporter 4.

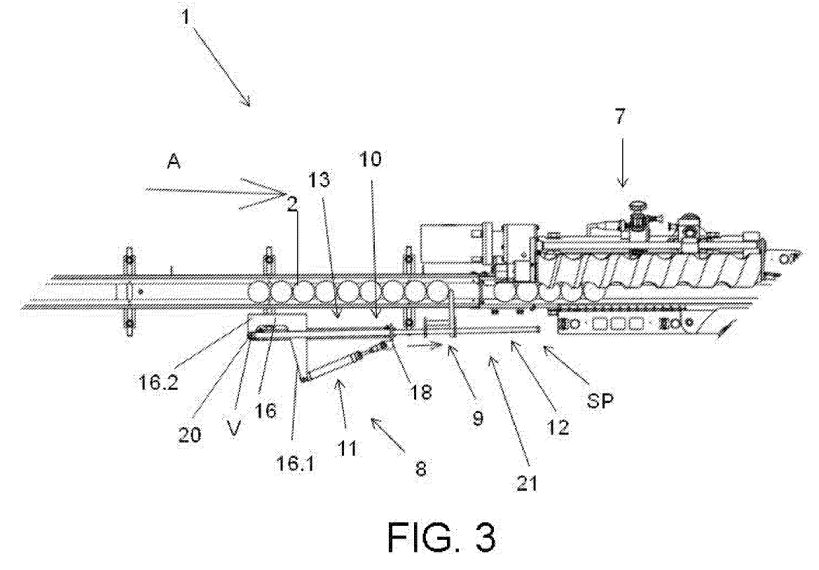

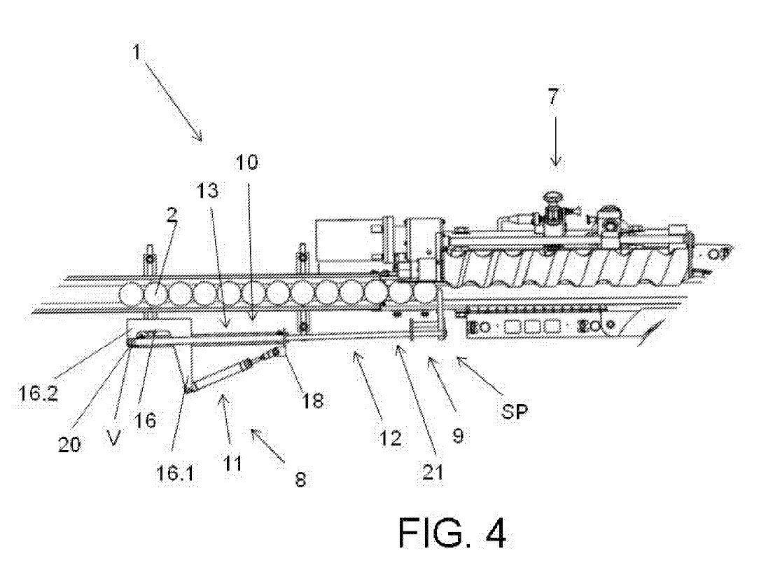

Corresponding to FIG. 2, the stop position SP, i.e. the effective position of the stopping arrangement 9, is finally reached, in that the jib 12 and therefore the stopping arrangement 9 is pivoted from the side, in one possible exemplification into an intermediate space between two containers 2 following one another in the transport direction A. This is in one possible exemplification achieved by the second drive unit 11 being moved out by a definable distance in the direction of the acceleration path 14, and therefore causing the jib 12 to pivot around a vertical axis V. Once this situation of the container stop mechanism 8 has been moved into, represented in FIG. 2, the first drive unit 10 then exerts a braking effect on the stopping arrangement 9, and therefore also on the container flow following in the transport direction A, due to the stopping arrangement 9 being moved by the first drive unit 10 in the transport direction A at a speed which is reduced in comparison with the transport speed of the transporter 4. By holding back the containers 2 using the container stop mechanism 8, while the transporter 4 continues to circulate, an increasingly large gap is thereby formed in the container flow, or the container flow at the container separating element 7 is completely interrupted (FIGS. 3 and 4). In this situation, FIG. 4 shows the state of the container transport path 1, in which the stopping arrangement 9 is still in its stop position SP, and in which, due to the holding back of the containers 2, the part of the container transport path 1 following onto the stopping arrangement 9 in the transport direction A, as well as the downstream container treatment machine 3, can be run until they are completely empty. For this purpose, the stopping arrangement 9 is in one possible exemplification moved as far as the second stop 14.2 and then stopped at this stop.

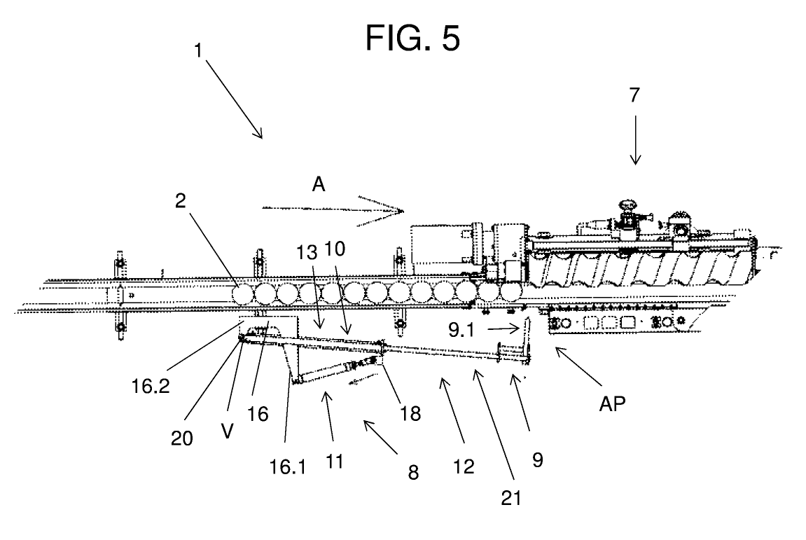

Corresponding to FIG. 5, the release of the container flow is initiated by the jib 12 being pivoted by the second drive unit 11 in the direction of its initial position AP in FIG. 1, and therefore the stopping arrangement 9 moves out of engagement with the containers 2 of the container flow. Due to the stopping arrangement 9 is now in its non-effective position, the container block is suspended and the container flow is then conveyed again as a single-track densely packed container flow via the container transport path 1 and via the container separating element 7 of the container handling machine 3. By using the first drive unit 10, the stopping arrangement 9 is moved back along the acceleration path 14, against the transport direction A, into the initial position AP, in which it in one possible exemplification comes to lie in contact with the first stop 14.1. Accordingly, the container stop mechanism 8 according to the present application is again in its initial position AP from FIG. 1.

In other words, containers 2 can be moved in a line along a transport path on the transporter or conveyor 4, which can be in the form of a conveyor belt. The container stopping arrangement 8 is positioned next to or adjacent the conveyor 4. The container stopping arrangement 8 includes a slidable or movable stopping device 9 supported on a jib 12. The jib 12 can be in the form of an elongated rod or similar structure. The stopping device 9 includes a stopping structure 9.1, which can be in the form of an arm or plate or blade. In general, the stopping structure 9.1 is to be moved into and out of the transport path of the containers 2 to create space between adjacent groups of containers 2. To further explain, when desired, the container stopping arrangement 8 can be used to separate groups of containers 2. The general operating principle is that the stopping structure 9.1 can be inserted in between two adjacent containers 2 to first separate the two containers 2. The stopping structure 9.1 is moved, either at the time of insertion between the containers 2 or thereafter, at a speed that is less than the speed of movement of the transporter 4. As a result, the containers 2 downstream of the stopping structure 9.1 continue along unimpeded at the same speed, whereas the containers upstream of the stopping structure 9.1 are impeded and continue along at the slower speed of the stopping structure 9.1. A gap therefore forms between the downstream container group and the upstream container group as the faster downstream container group pulls further away from the slower upstream container group.

FIGS. 1 to 5 depict this operation of the container stopping mechanism 8 according to at least one possible exemplification. In FIG. 1, the jib 12 is at an angle to the conveyor 4, such that the stopping structure 9.1 is located out of the transport path of the containers 2. This state of the container stopping arrangement 8 is known as the initial position AP. Alternatively, the state of the container stopping arrangement 8 at this point could be considered a disengaged state because the stopping structure 9.1 is located completely out of the transport path of the containers 2 and thus is not impeding the movement of the containers 2. When it is time to insert the stopping structure 9.1 in between two groups of containers 2, the first drive unit 10 first moves the stopping device 9 along the jib 12. The first drive unit 10 is designed to accelerate the stopping device 9 such that the stopping device 9 is moving at a speed that is similar to the speed of the conveyor 4. In other words, the movement speed of the stopping device 9 should essentially match the movement speed of the containers 2 so that when the stopping structure 9.1 is inserted in front of a container 2, the movement of the container 2 is not abruptly or suddenly impeded or stopped. The movement speed of the stopping device 9, at the moment prior to insertion of the stopping structure 9.1 between two containers 2, should be equivalent to or less than, but not substantially less than, the movement speed of the containers 2.

Once the stopping device 9 is moving at the desired speed, the second drive unit 11 can be activated to pivot the lever arrangement 15 about the vertical axis V until the lever arrangement 15 and the jib 12 are located parallel or essentially parallel to the conveyor 4, as shown in FIG. 2. At this point the stopping structure 9.1 is projecting between two adjacent containers 2. This state of the container stopping arrangement 8 is known as the stop position SP. Alternatively, the state of the container stopping arrangement 8 at this point could be considered an engaged state because the stopping structure 9.1 is located at least partially in the transport path of the containers 2 and thus may impede the movement of the containers 2. As shown in FIGS. 3 and 4, the stopping structure 9.1 impedes the movement of the upstream containers 2 such that a gap forms between the upstream containers 2 and the downstream containers 2. The movement speed of the stopping device 9 is gradually decreased by the first drive unit 10 in order to gradually slow the movement speed of the upstream containers 2, and thereby increase the gap between the upstream containers 2 and the downstream containers 2. If desired, the movement of the stopping device 9, and thus the stopping structure 9.1, can be decreased to a complete stop, such as in the position shown in FIG. 4, in order to completely stop the movement of the upstream containers 2. The gradual deceleration of the stopping device 9 minimizes or prevents substantial or damaging impact forces between adjacent upstream containers 2 that might otherwise occur if the containers 2 were suddenly or abruptly stopped or decelerated quickly. When it is time to resume movement of the upstream containers 2, the second drive unit 11 can be activated to pivot the lever arrangement 15 about the vertical axis V until the lever arrangement 15 and the jib 12 are located at an angle to the conveyor 4 and the stopping structure 9.1 is out of the transport path of the containers 2. In other words, the second drive unit 11 is used to move the container stopping arrangement 8 from the disengaged state (FIG. 1) to the engaged state (FIGS. 2-4) and then back into the disengaged state (FIG. 5). Once the container stopping arrangement 8 is in the disengaged state in FIG. 5, the first drive unit 10 is activated to move the stopping device 9 back to the position shown in FIG. 1. The first stop 14.1 and the second stop 14.2 (FIG. 2) can be utilized to limit the movement of the stopping device 9 along the jib 12 to ensure that the stopping device 9 is not moved too far in either direction.

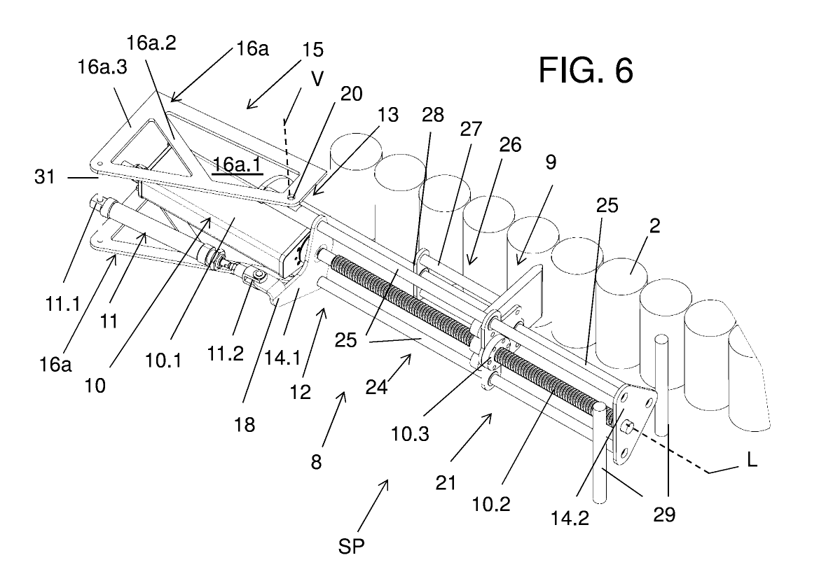

FIG. 6 shows a further exemplification variant of a container stop mechanism 8 according to the present application, with a jib 12, in a schematic side representation. In differentiation to FIGS. 1 to 5, the jib 12 in FIG. 6 exhibits a perceptibly shorter lever region 13, connected to which, however, again extending essentially in the longitudinal direction L of the jib 12, is the acceleration region 21, extending by at least the acceleration path 14. Provision can be made for the transition between the lever region 13 and the acceleration region 21 to be formed by the holding element 18.

The acceleration path 14 can in this situation comprise the stopping arrangement 9, formed as a slide, which is guided on a slide guide 24 along the acceleration path 14. The slide guide 24 can in this situation comprise the guide bars 25, oriented essentially parallel to the longitudinal axis L, these bars forming in one possible exemplification a triangular structure as a slide guide 24. The first drive unit 10 can in this situation be configured as a spindle drive, with, for example, an encapsulated electric motor 10.1. The electric motor 10.1 can be used to set one spindle rod 10.2 in rotation, which spindle rod 10.2 in turn interacts with a spindle nut 10.3. The spindle nut 10.3 is connected to or forms part of or is associated with the slide 9. The slide 9 can thus be moved in both directions along the slide guide 24 by a rotation of the spindle rod 10.2 as a function of the direction of rotation of the electric motor 10.1. The electric motor can be, for example, a servomotor or an asynchronous motor.

In order to avoid, restrict, and/or minimize a tilting of the slide 9 along the slide guide 24, such as in the direction of the longitudinal axis L, a guide device 26 can be allocated to the slide 9. The guide device 26 can, in this situation, comprise a slide guide rod 27, oriented in one possible exemplification parallel or substantially parallel to the guide rods 25, which can be arranged with its end allocated to the slide 9 actually on the slide 9, and, at its end facing away from the slide 9, can comprise a guide element 28, which is configured in such a way that the guide device 26 can be moved along the slide guide 24.

Additionally, in one possible exemplification, on both sides of the jib 12, in the region of the stop 14.2, a further stopping arrangement or device 29 can be provided, configured as stops, which can be configured, for example, in the form of tubes or rods.

Provision can also be made for the stops 14.1 and 14.2 to be parts of the slide guide 24, and in this situation, in one possible exemplification, to form the face-side termination elements to hold the guide rods 25. In addition, the stop 14.1 can also be configured as a holding element 18, and therefore fulfils the function of an actual stop 14.1, as well as a holding element 18, and, in addition, as a face-side termination element to hold the guide rods 25.

In differentiation to FIGS. 1 to 5, the lever arrangement 15 connects to the lever region 13 of the jib 12 essentially beneath the vertical axis V, i.e. the rotation axis 20. Provision can be made in this situation for the lever arrangement 15 to comprise at least one lever element 16, configured as a lever element plate 16a, with a plurality of openings 16a.1, which are oriented in relation to one another in such a way that, between the respective openings 16a.1, at least one connection web section 16a.2 is formed, and the openings 16a.1 are closed off to the outside by a circumferential frame section 16a.3. In the present exemplification variant of FIG. 6, in this situation two lever element plates 16a are provided, oriented essentially parallel to one another, which accommodate the jib 12, which is mounted on bearings so as to rotate between them at the rotation axis 20. In addition, at least one connection element 31, such as a connecting rod, can be provided between the lever element plates 16a, this connection element being configured at least such as to accommodate the first end 11.1 of the second drive unit 11 with rotational movement. Accordingly, in this exemplification variant too, the jib 12 can be pivoted by the second drive unit 11 around the vertical axis V, or the rotation axis 20 respectively.

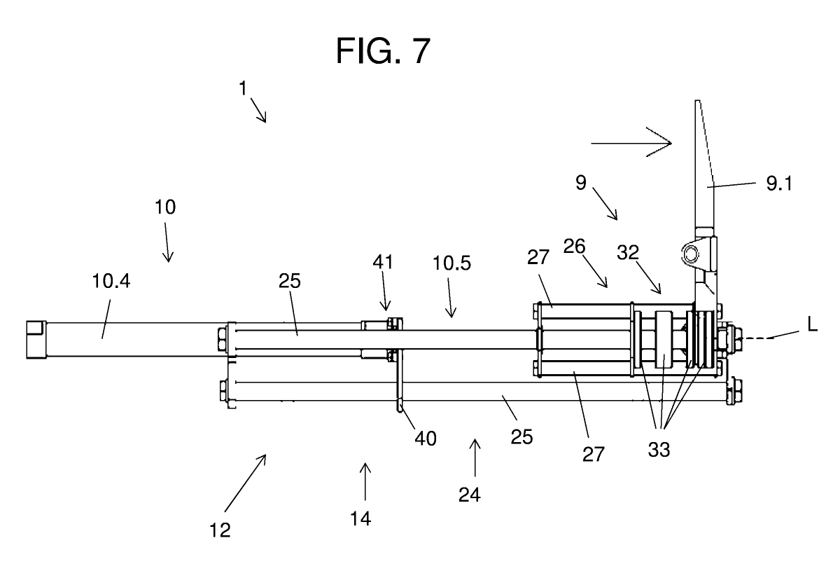

FIG. 7 shows a further exemplification variant of the container stop mechanism 1 according to the present application, in a schematic view from above. In the representation in FIG. 7, however, for reasons of better overview, those components or component groups of the container stop mechanism 1 are shown which are necessary and/or desired for the description of the function.

In one possible exemplification, FIG. 7 shows in this situation the acceleration path 14 of the jib 12, which, like the exemplification in FIG. 6, can be configured as a slide guide 24. Accordingly, the slide guide 24, like the exemplification from FIG. 6, likewise comprises a plurality of guide rods 25, which can in one possible exemplification be arranged parallel or substantially parallel to the longitudinal axis L. Also shown schematically is the first drive unit 10, which, according to the exemplification from FIG. 7, can be configured as a linear drive, in one possible exemplification as a pneumatic cylinder device, with at least one cylinder housing 10.4 and a cylinder piston 10.5. In at least one possible exemplification, the working cylinder can be accommodated or held in an elastic mounting arrangement by at least one holding arrangement or device 40, with at least one spring sheet 41, provided at the guide rod 25. Not shown in FIG. 7 in this situation, in one possible exemplification, is the mechanical connection of the first drive unit 10 to the lever element 16, which connection can be released, as in the foregoing exemplification variants in FIGS. 1 to 6.

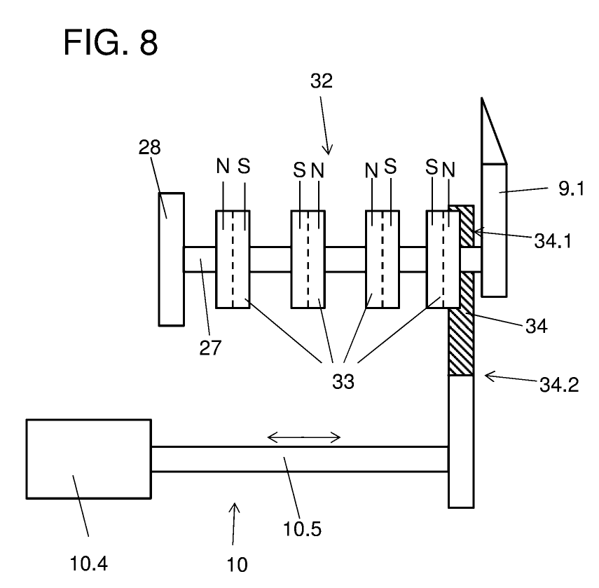

The exemplification variant from FIG. 7 further comprises a guide device 26 for the holding arrangement 9, which, in differentiation from the previous exemplifications, comprises an additional damping device 32. In one possible exemplification, the damping device 32 in this situation is configured as a magnetic damping device, which in one possible exemplification comprises a plurality of magnets 33, in one possible exemplification permanent magnets. A detailed explanation of the additional damping device 32 is provided in the description relating to FIG. 8. By using the damping device 32, a more gentle and more jerk-free braking of the container flow is achieved, in that the stopping arrangement 9, after the movement, i.e. intervention, into the container flow, is additionally moved in the transport direction A with the container flow by a defined path distance, by using the damping device 32, before the stopping arrangement 9 reaches its final stop position SP. In one possible exemplification, the stopping arrangement 9 is configured so as to be movable axially by the damping device 32 along the acceleration path 14, and specifically relative to the longitudinal movement initiated along the acceleration path 14 by the first drive unit 10.

For this purpose, in one possible exemplification the engagement section 9.1 of the stopping arrangement 9 is arranged at the free end of at least one slide guide rod 27 of the guide device 26. At the free end, facing away from the engagement section 9.1, the guide element 28 can be provided, which forms a mechanical stop or a delimitation for the plurality of magnets 33 arranged such as to be axially movable along the slide guide rod 27. In one possible exemplification, the plurality of magnets 33 are arranged aligned along the slide guide rod 27 in such a way that mutually repelling poles, i.e. the like poles, lie opposite one another, such that, in the initial position AP, without any load imposed, a distance interval is provided between adjacent magnets 33 in each case. In one possible exemplification, corresponding north poles N or south poles S respectively of the magnets 33 lie opposite one another in each case. In one possible exemplification, the individual magnets 33 comprise an identical or approximately identical magnetic field strength, such that, in the initial position AP, without any load imposed, a uniform distance interval is provided between the adjacent magnets 33 in each case.

In addition to this, arranged at the slide guide rod 27 is a driver catch 34 with its first end 34.1, and specifically in such a way that the slide guide rod 27 is configured such as to be displaceable, i.e. movable, essentially parallel to the longitudinal axis L. The driver catch 34 is further securely connected by its second end 34.2, opposite the first end 34.1, to the first drive unit 10, in one possible exemplification to the free end of the cylinder piston 10.5. In one possible exemplification, the driver catch 34 can be arranged with its first end 34.1 next to engagement section 9.1 at the slide guide rod 27.

If the container stop mechanism 1 is moved from its initial position AP into the stop position SP, the stopping arrangement 9, in one possible exemplification the engagement section 9.1, engages into the container flow which is to be braked, in one possible exemplification into the intermediate space between two containers 2 following one another, in such a way that the stopping arrangement 9 are taken along with the container flow being conveyed in the transport direction A. As a result, the mutually repelling magnets 33 are pressed against the driver catch 34, such that, as the compaction increases, i.e. the space between two adjacent magnets 33 decreases, an increasing force builds up. In this situation, due to the kinematic forced coupling between the driver catch 34 and the first drive unit 10, as described heretofore, this force is transferred in one possible exemplification onto the cylinder piston 10.5 of the first drive unit 10, which finally leads to the stopping arrangement 9 coming to a standstill after a certain path distance has been covered, and the container flow is therefore stopped in the stop position SP. In other words, therefore, due to the floating mounting arrangement of the plurality of magnets 33 on the slide guide rod 27, a floating mounted magnet column is built up, which determines the buffer path or spring path of the damping device 32. The buffer path or spring path can be varied or determined by the magnetic field strengths of the individual magnets 33, as well as by the length of the slide guide rod 27.

In other words, according to one possible exemplification, the stopping mechanism of FIGS. 7 and 8 minimizes or essentially prevents or prevents any jarring impact when the stopping structure 9.1 is first inserted in between the containers 2. For example, in the exemplifications shown in FIGS. 1-6, it is desirable to try to match the movement speed of the stopping arrangement 9 as closely as possible to the movement speed of the containers 2. The speeds should be matched so that when the stopping structure 9.1 is inserted in front of a container 2, the container 2 does not impact against the stopping structure 9.1, which would result in a chain reaction in which all of the subsequent containers 2 in the group impact against the containers 2 ahead of them. If, for example, the stopping structure 9.1 was inserted in between the containers 2 while the stopping structure was being moved at a speed slower than the movement speed of the containers 2, the containers 2 would impact against the stopping structure 9.1, with the force of impact increasing directly proportional to the difference in speeds.

In the exemplification shown in FIGS. 7 and 8, a passive braking system is utilized in the sense that the containers 2 move the stopping structure 9.1. This design minimizes or avoids the impacts that can occur when the stopping structure 9.1 is driven by a drive unit. For the exemplification shown in FIGS. 7 and 8, in operation, when the stopping structure 9.1 is inserted into the stream of containers 2, the containers 2 push the stopping structure 9.1 forward in the transport direction A. The slide guide rod 27 is in turn pulled forward such that the guide element 28 is pulled toward the magnets 33. The guide element 28 thereby compresses the magnets 33 between the guide element 28 and the driver catch 34. The opposing magnetic force between the magnets 33 increases as the magnets 33 are pressed closer together. As a result, an increased force is exerted on the driver catch 34, which in turn causes a pulling or extraction of the cylinder piston 10.5. When the cylinder piston 10.5 reaches its maximum extraction or extension, the movement of the piston 10.5 stops and the movement of the containers 2 is completely stopped. To summarize, the advantages of the exemplification in FIGS. 7 and 8 are that the containers 2 move the stopping structure 9.1 to minimize or prevent abrupt or jarring impacts when the stopping structure 9.1 is inserted into the container stream, and additional substantial impacts are minimized or prevented by the gradual cushioning or braking effect of the magnetic forces between the loosely mounted magnets 33.

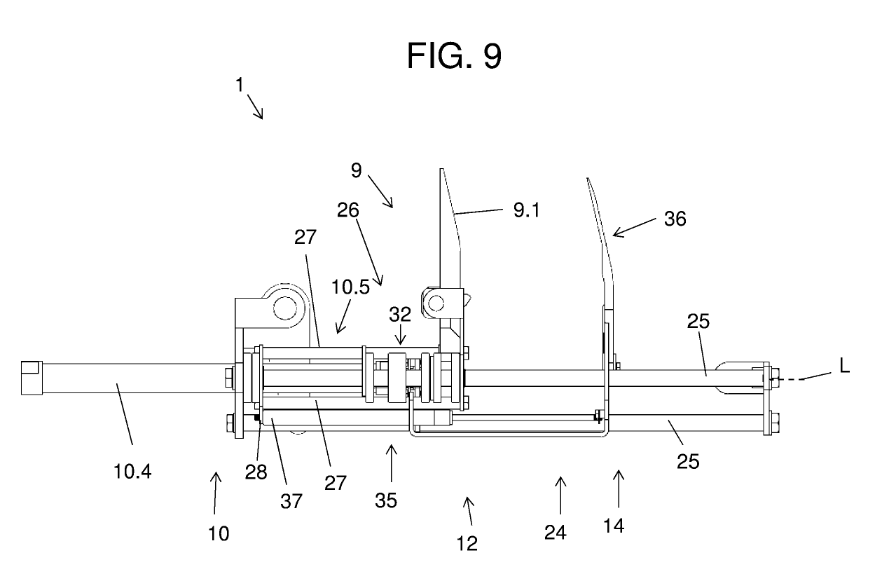

Shown in FIG. 9 is a section from a further exemplification variant of the container stop mechanism 1 according to the present application, in a schematic view from above, which in differentiation to the exemplifications from FIGS. 7 and 8 makes provision for an additional support device 35, comprising at least a support element 36, as well as an actuating device 37 interacting with the support element 36. Shown in the representation from FIG. 9, for reasons of better overview, are or may be the components or component groups of the container stop mechanism 1 which are necessary and/or desired for the function.

In this situation, the support device 35 can be actuated independently by way of the actuation device 37 for the first drive unit 10, in such a way that a relative movement is possible between the stopping arrangement 9 and the support element 36. In one possible exemplification, the support device 35 is configured such that, on reaching the stop position SP, it supports the last containers which are still to be transported further, and specifically in such a way that the support element 36 is moved in contact with the last container 2 still to be transported further, in the transport direction A, in one possible exemplification until this container 2 is transferred at the container separating element 7. As a result, due to the support device 35, a defined build-up pressure of the further transported container flow is assured, and therefore, in one possible exemplification, tilting is avoided and/or restricted and/or minimized of the last contained 2 to be transported further, on the transporter 4.

In at least one possible exemplification, the support element 36 of the support device 35 can be provided such as to be movable at the guide rod 25. Moreover, the actuation device 36 can be arranged at the guide element 28. In one possible exemplification, the actuation device 36 can be configured as a gas pressure spring or pneumatic cylinder. In the situation of the actuation device 36 being configured as a gas pressure spring, a release device can be provided, which, at the moment of the stopping arrangement 9 pivoting into the container flow, is released in such a way that the support element 36 presses against the last container 2 which is still to be transported further.

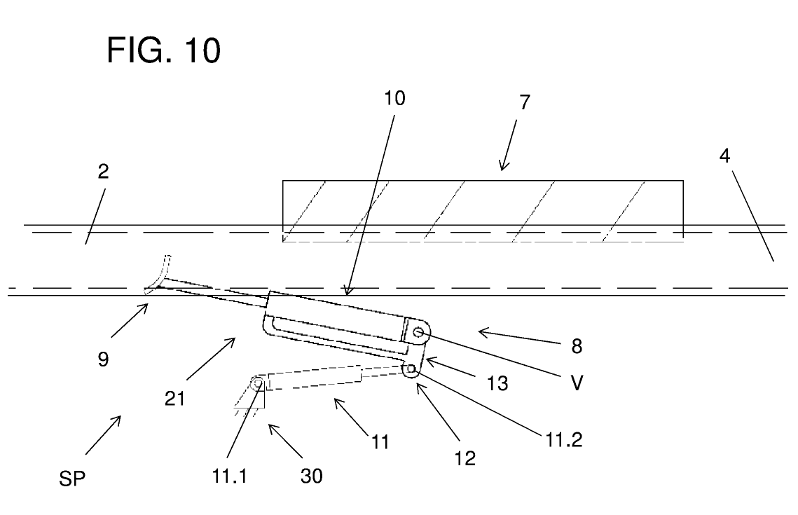

FIG. 10 shows a further exemplification variant of a container stop mechanism 8 according to the present application, in which the acceleration range 21 and the lever range 13 of the jib 12 are in one possible exemplification oriented by ninety degrees in relation to one another. The vertical axis V can be provided in this situation in the transition region between the acceleration region 21 and the lever region 13. In this situation, at the end of the lever region 13, facing away from the vertical axis V, the second end 11.2 of the second drive unit 11 can be located, arranged to be rotationally movable at the jib 12, while the first end 11.1 can be arranged at a fixed bearing element 30, again rotationally movable, such that the jib 12 is configured so as to pivot around the vertical axis V, by the second drive unit 11.

Provision can further be made for the first drive unit 10, by which the stopping arrangement 9 can be moved in one possible exemplification along the acceleration path 14 of the jib 12, to be configured as a linear drive, for one possible exemplification as a retractable and extendable pneumatic cylinder device, arranged at which is the holding arrangement 9. For example, the second drive unit 11 can also be a linear drive, in one possible exemplification a retractable and extendable pneumatic cylinder device.

According to FIG. 7, the pneumatic cylinder device is represented in the extended state, in which the container stop mechanism 8 engages into the container flow by the holding arrangement 9, and the jib 12 is pivoted, by the second drive unit 11, about its axis V into the stop position SP. By analogy with the description for FIGS. 1 to 5, for braking and/or stopping and/or separating individual containers 2 of the container flow in the transport direction A, the holding arrangement 9 is moved more slowly relative to the transport speed of the transporter 4, along the acceleration path 14 in the direction of the lever region 13. In order to release the container flow, the jib 12, together with the holding element 9, is pivoted by the second drive unit 11 into its initial position AP, not shown.

The present application has been described heretofore on the basis of disclosed exemplifications. It is understood that numerous modifications and derivations are possible, without thereby departing from the concept underlying the present application.

For example, provision is made for a further exemplification of the present application that the jib 12, together with the holding element 9, engages directly into the container flow without prior acceleration of the jib 12, such that the jib 12 is then first accelerated by the container flow, and then brakes or decelerates the container flow as described heretofore.

This procedure is made possible by the fact that the device provided according to the present application comprises such a low mass that an acceleration due to the container flow is possible, without the container flow being braked in an undesirable manner.

Provision is further made for a further exemplification that at least one sensor device is arranged on the jib 12 and/or on the holding arrangement 9. This sensor device serves, for example, to detect a gap in the container flow and/or the speed of the container flow and/or containers of the container flow.

The information detected by the at least one sensor is used, for example, in conjunction with a computer unit, so as to control the movement sequence of the jib 12 and/or of the holding element 9 in such a way that neither the containers of the container flow nor the jib 12 nor the holding element 9 are damaged. For example, the information is used in order to control the movement sequence in such a way that the holding element 9 enters into a gap in the container flow. It is likewise possible for the movement sequence to be controlled in such a way that the holding element 9 does not come impinge perpendicularly or essentially perpendicularly onto the wall of a container.

The present application relates to a container stop mechanism for controlled braking and/or stopping and/or separating at least one container in a container flow moving in a transport direction on a container transport path in accordance with the preamble of claim 1, and to a method for controlled braking and/or stopping and/or separating at least one container in a container flow moving in a transport direction on a container transport path according to the preamble of claim 15. One aspect according to the container stop mechanism may lie in that the at least one stopping arrangement and the first and second drive unit are provided on a jib extending along the container transport path, which jib is configured so as to be pivotable around a vertical or substantially vertical axis between the initial position and the stop position by the second drive unit.

One feature or aspect of an exemplification is believed at the time of the filing of this patent application to possibly reside broadly in a container stop mechanism for controlled braking and/or stopping and/or separating at least one container 2 in a container flow moving in a transport direction A on a container transport path 1, comprising at least one stopping arrangement 9 for the at least partial engagement into the container flow, at least one first drive unit 10, by which the stopping arrangement 9 can be driven in a controlled manner along the container transport path 1 in and/or against the transport direction A, and at least one second drive unit 11, by which the holding arrangement 9 can be moved in a controlled manner between an initial position AP not engaging into the container flow 11 and a stop position SP engaging into the container flow, wherein the at least one holding arrangement 9, as well as the first and second drive units 10, 11 are provided at a jib 12 extending along the container transport path 1, which is configured such as to be pivotable about a vertical axis V between the initial position AP and the stop position SP.

Another feature or aspect of an exemplification is believed at the time of the filing of this patent application to possibly reside broadly in the container stop mechanism, wherein the jib 12 comprises a lever region 13 interacting with a lever arrangement 15, as well as an acceleration region 21 comprising an acceleration path 14 for the holding arrangement 9.

Yet another feature or aspect of an exemplification is believed at the time of the filing of this patent application to possibly reside broadly in the container stop mechanism, wherein the first drive unit 10 is configured in such a way that it accelerates the holding arrangement 9 out of the initial position AP of the jib 12, first along the acceleration path 14 in the transport direction A, before it moves the stopping arrangement 9, in the stop position SP of the jib 12, at a speed which is at least reduced in relation to the transport speed of a transporter 4.

Still another feature or aspect of an exemplification is believed at the time of the filing of this patent application to possibly reside broadly in the container stop mechanism, wherein the second drive unit 11 is allocated with a first end 11.1 to the lever arrangement 15 and with a second end 11.2 to the jib 12, in such a way that the jib 12 can be pivoted by the second drive unit around the vertical axis V between the initial position AP and the stop position SP.

A further feature or aspect of an exemplification is believed at the time of the filing of this patent application to possibly reside broadly in the container stop mechanism, wherein the first drive unit 10 and/or the second drive unit 11 is configured as a linear drive, for one possible exemplification as a pneumatic cylinder device.

Another feature or aspect of an exemplification is believed at the time of the filing of this patent application to possibly reside broadly in the container stop mechanism, wherein the pivotable jib 12 in the initial position AP is configured at least with its acceleration region 21 essentially parallel to the container transport path 1.

Yet another feature or aspect of an exemplification is believed at the time of the filing of this patent application to possibly reside broadly in the container stop mechanism, wherein the lever region 13 and the acceleration region 21 of the jib 12 are configured as oriented towards one another along a longitudinal axis L.

Still another feature or aspect of an exemplification is believed at the time of the filing of this patent application to possibly reside broadly in the container stop mechanism, wherein the acceleration path 14 of the jib 12 comprises, at the end allocated to the lever region 13, at least one first stop 14.1, and, at the end facing away from the lever region 13, at least one second stop 14.2.

A further feature or aspect of an exemplification is believed at the time of the filing of this patent application to possibly reside broadly in the container stop mechanism, wherein the acceleration path 14 is configured as a slide guide 24, which comprises at least one guide rod 25 oriented parallel or essentially parallel to the longitudinal axis L, along which a holding arrangement 9 configured as a slide can be moved.

Another feature or aspect of an exemplification is believed at the time of the filing of this patent application to possibly reside broadly in the container stop mechanism, wherein the first drive unit 10 is configured as a spindle drive with at least one electric motor 10.1, by which at least one spindle rod 10.2 can be set in rotation, which in turn interacts at least one spindle nut 10.3, this nut being allocated to the holding arrangement 9 configured as a slide, such that the slide 9 can be moved by rotation of the at least one spindle rod 10.2 along the slide guide 24 in both directions, depending on the rotation of the electric motor 10.1.

Yet another feature or aspect of an exemplification is believed at the time of the filing of this patent application to possibly reside broadly in the container stop mechanism, wherein the electric motor 10.1 is configured as a servomotor or asynchronous motor.

Still another feature or aspect of an exemplification is believed at the time of the filing of this patent application to possibly reside broadly in the container stop mechanism claims, wherein the slide 9 comprises a guide device 26, which comprises at least one guide rod 25, which encompasses at least one slide guide rod 27 provided parallel or essentially parallel to the at least one guide rod 25, as well as at least one guide element 28 which can be moved along the slide guide 24.

A further feature or aspect of an exemplification is believed at the time of the filing of this patent application to possibly reside broadly in the container stop mechanism, wherein a damping device 32 is allocated to the guide device 26.

Another feature or aspect of an exemplification is believed at the time of the filing of this patent application to possibly reside broadly in the container stop mechanism, wherein the damping device 32 comprises at least a plurality of magnets 33 which are freely movable along the slide guide rod 27 and in each case are configured as permanent magnets.

One feature or aspect of an exemplification is believed at the time of the filing of this patent application to possibly reside broadly in the container stop mechanism, wherein the plurality of magnets 33 are arranged at the slide guide rod 27 in such a way that in each case mutually repelling north poles N or, respectively, south poles S of the corresponding adjacent magnets 33 are at least partially located opposite one another.

Another feature or aspect of an exemplification is believed at the time of the filing of this patent application to possibly reside broadly in the container stop mechanism, wherein the plurality of magnets 33 comprise an approximately identical field strength.

Yet another feature or aspect of an exemplification is believed at the time of the filing of this patent application to possibly reside broadly in the container stop mechanism, wherein the first and second stops 14.1, 14.2 are constituent parts of the slide guide 24 and form the face-side closure elements for holding the at least one guide rod 25.

Still another feature or aspect of an exemplification is believed at the time of the filing of this patent application to possibly reside broadly in the container stop mechanism, wherein the acceleration region 21 and the lever region 13 of the jib 12 are oriented by ninety degrees in relation to one another.

One feature or aspect of an exemplification is believed at the time of the filing of this patent application to possibly reside broadly in a method for the controlled braking and/or stopping and/or separating of at least one container 2 in a container flow moving in a transport direction A on a container transport path 1, wherein at least one stopping arrangement 9, configured for the at least partial engagement into the container flow, is driven in a controlled manner by at least one first drive unit 10 along the container transport path 1 in and/or against the transport direction A, and wherein the at least one stopping arrangement 9 is moved in a controlled manner by at least one second drive unit 11 between an initial position AP, not engaging into the container flow, and a stop position SP engaging into the container flow, wherein a jib 12, extending along the container transport path 1, provided at which are at least one holding arrangement 9 as well as the first and second drive units 10, 11, is pivoted by the second drive unit 11 around a vertical axis V between the initial position AP and the stop position SP.

The components disclosed in the patents, patent applications, patent publications, and other documents disclosed or incorporated by reference herein, may possibly be used in possible exemplifications of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one exemplification of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various exemplifications may be used with at least one exemplification or all of the exemplifications, if more than one exemplification is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible exemplification of the present application . . . ” may possibly not be used or useable in any one or more exemplifications of the application.

The sentence immediately above relates to patents, patent applications, patent publications, and other documents either incorporated by reference or not incorporated by reference.

The following patents, patent applications, patent publications, and other documents are hereby incorporated by reference as if set forth in their entirety herein except for the exceptions indicated herein: DE 30 15 203 C2, having the title “Bottle conveyor with star wheel lockable to stop bottles—has wheel carried on support with limited parallel movement against damper”, published on Aug. 30, 1984.

All of the patents, patent applications, patent publications, and other documents, except for the exceptions indicated herein, which were cited in the German Office Action dated Nov. 25, 2015, and/or cited elsewhere, as well as German Office Action document itself, are hereby incorporated by reference as if set forth in their entirety herein except for the exceptions indicated herein, as follows: DE 698 03 456 T2, having the title “METHOD AND DEVICE FOR CUSHIONED STOPPAGE AND ACCOMPANYING OF CONTAINERS ALONG A CONVEYING LINE FOR CONTAINERS”, published on Sep. 5, 2002; and U.S. Pat. No. 4,662,500, having the title “Conveyor stop gate”, published on May 5, 1987.

All of the patents, patent applications, patent publications, and other documents, except for the exceptions indicated herein, which were cited in the International Search Report dated Feb. 19, 2016, and/or cited elsewhere, as well as the International Search Report document itself, are hereby incorporated by reference as if set forth in their entirety herein except for the exceptions indicated herein, as follows: JP H08 268550 A, having the title “BAR STEEL ALIGNING DEVICE”, published on Oct. 15, 1996; DE 36 22 980 A1, having the title “Halting/shock-absorbing device for transported objects”, published on Jan. 22, 1987; and U.S. Pat. No. 5,419,425, having the title “Apparatus and method for loading lumber onto a high-speed lugged transfer deck”, published on May 30, 1995.

The corresponding foreign and international patent publication applications, namely, Federal Republic of Germany Patent Application No. 10 2014 118 264, filed on Dec. 10, 2014, having inventor Andreas FAHLDIECK, and DE-OS 10 2014 118 264 and DE-PS 10 2014 118 264, and International Application No. PCT/EP2015/078746, filed on Dec. 7, 2015, having WIPO Publication No. WO 2016/091767 A1 and inventor Andreas FAHLDIECK, are hereby incorporated by reference as if set forth in their entirety herein, except for the exceptions indicated herein, for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications, patent publications, and other documents, except for the exceptions indicated herein, are hereby incorporated by reference as if set forth in their entirety herein except for the exceptions indicated herein.

The purpose of incorporating the corresponding foreign equivalent patent application(s), that is, PCT/EP2015/078746 and German Patent Application 10 2014 118 264, is solely for the purposes of providing a basis of correction of any wording in the pages of the present application, which may have been mistranslated or misinterpreted by the translator, and to provide additional information relating to technical features of one or more exemplifications, which information may not be completely disclosed in the wording in the pages of this application.

Statements made in the original foreign patent applications PCT/EP2015/078746 and DE 10 2014 118 264 from which this patent application claims priority which do not have to do with the correction of the translation in this patent application are not to be included in this patent application in the incorporation by reference.

Any statements about admissions of prior art in the original foreign patent applications PCT/EP2015/078746 and DE 10 2014 118 are not to be included in this patent application in the incorporation by reference, since the laws relating to prior art in non-U.S. Patent Offices and courts may be substantially different from the Patent Laws of the United States.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the exemplifications therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more exemplifications of the patents, patent applications, patent publications, and other documents, are not considered to be incorporated by reference herein for any of the patents, patent applications, patent publications, and other documents cited herein.

The description of the exemplification or exemplifications is believed, at the time of the filing of this patent application, to adequately describe the exemplification or exemplifications of this patent application. However, portions of the description of the exemplification or exemplifications may not be completely applicable to the claims as originally filed in this patent application, as amended during prosecution of this patent application, and as ultimately allowed in any patent issuing from this patent application. Therefore, any statements made relating to the exemplification or exemplifications are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the exemplification or exemplifications, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The exemplifications of the invention described herein above in the context of the preferred exemplifications are not to be taken as limiting the exemplifications of the invention to all of the provided details thereof, since modifications and variations thereof may be made without departing from the spirit and scope of the exemplifications of the invention.

### AT LEAST PARTIAL NOMENCLATURE

1 Container transport path
2 Container
3 Container handling machine
4 Transporter
5 Guide rails
6 Container intake facility
7 Container separating element
8 Container stop mechanism
9 Stopping arrangement
9.1 Engagement section
10 First drive unit
10.1 Electric motor
10.2 Spindle rod
10.3 Spindle nut
10.4 Cylinder housing
10.5 Cylinder piston
11 Second drive unit
11.1 First end
11.2 Second end
12 Jib
13 Lever region
14 Acceleration path
14.1 First stop
14.2 Second stop
15 Lever arrangement
16 Lever element
16.1 First limb
16.2 Second limb
16a Lever element plate
16a.1 Opening
16a.2 Connection web section
16a.3 Frame section
18 Holding element
20 Rotation axis
21 Acceleration region
24 Slide guide
25 Guide rod
26 Guide device
27 Slide guide rod
28 Guide element
29 Stop arrangement
30 Bearing element
31 Connection element
32 Damping device
33 Magnet
34 Driver catch
34.1 First end
34.2 Second end
35 Support device
36 Support element
37 Actuation device
40 Holding arrangement
41 Spring plate
A Transport direction
V Vertical axis
L Longitudinal axis
AP Initial position
SP Stop position
N North pole
S South pole

What is claimed is:

1. Container stop mechanism for controlled braking and/or stopping and/or separating at least one container in a container flow moving in a transport direction on a container transport path, comprising at least one stopping arrangement for the at least partial engagement into the container flow, at least one first drive unit, by which the stopping arrangement can be driven in a controlled manner along the container transport path in and/or against the transport direction, and at least one second drive unit, by which the holding arrangement can be moved in a controlled manner between an initial position not engaging into the container flow and a stop position engaging into the container flow, wherein the at least one holding arrangement, as well as the first and second drive units are provided at a jib extending along the container transport path, which is configured such as to be pivotable about a vertical axis between the initial position and the stop position.

2. Container stop mechanism according to claim 1, wherein the jib comprises a lever region interacting with a lever arrangement, as well as an acceleration region comprising an acceleration path for the holding arrangement.

3. Container stop mechanism according to claim 2, wherein the first drive unit is configured in such a way that it accelerates the holding arrangement out of the initial position of the jib, first along the acceleration path in the transport direction, before it moves the stopping arrangement, in the stop position of the jib, at a speed which is at least reduced in relation to the transport speed of a transporter.

4. Container stop mechanism according to claim 3, wherein the second drive unit is allocated with a first end to the lever arrangement and with a second end to the jib, in such a way that the jib can be pivoted by the second drive unit around the vertical axis between the initial position and the stop position.

5. Container stop mechanism according to claim 4, wherein the first drive unit and/or the second drive unit is configured as a linear drive, for particular preference as a pneumatic cylinder device.

6. Container stop mechanism according to claim 5, wherein the pivotable jib in the initial position is configured at least with its acceleration region essentially parallel to the container transport path.

7. Container stop mechanism according to claim 6, wherein the lever region and the acceleration region of the jib are configured as oriented towards one another along a longitudinal axis.

8. Container stop mechanism according to claim 7, wherein the acceleration path of the jib comprises, at the end allocated to the lever region, at least one first stop, and, at the end facing away from the lever region, at least one second stop.

9. Container stop mechanism according to claim 8, wherein the acceleration path is configured as a slide guide, which comprises at least one guide rod oriented parallel to the longitudinal axis, along which a holding arrangement configured as a slide can be moved.

10. Container stop mechanism according to claim 9, wherein the first drive unit is configured as a spindle drive with at least one electric motor, by which at least one spindle rod can be set in rotation, which in turn interacts at least one spindle nut, this nut being allocated to the holding arrangement configured as a slide, such that the slide can be moved by rotation of the at least one spindle rod along the slide guide in both directions, depending on the rotation of the electric motor.

11. Container stop mechanism according to claim 10, wherein the electric motor is configured as a servomotor or asynchronous motor.

12. Container stop mechanism according to claim 11, wherein the slide comprises a guide device, which comprises at least one guide rod, which encompasses at least one slide guide rod provided parallel to the at least one guide rod, as well as at least one guide element which can be moved along the slide guide.

13. Container stop mechanism according to claim 12, wherein a damping device is allocated to the guide device.

14. Container stop mechanism according to claim 13, wherein the damping device comprises at least a plurality of magnets which are freely movable along the slide guide rod and in each case are configured as permanent magnets.

15. Container stop mechanism according to claim 14, wherein the plurality of magnets are arranged at the slide guide rod in such a way that in each case mutually repelling north poles or, respectively, south poles of the corresponding adjacent magnets are at least partially located opposite one another.

16. Container stop mechanism according to claim 15, wherein the plurality of magnets comprise an approximately identical field strength.

17. Container stop mechanism according to claim 16, wherein the first and second stops are constituent parts of the slide guide and form the face-side closure elements for holding the at least one guide rod.

18. Container stop mechanism according to claim 6, wherein the acceleration region and the lever region of the jib are oriented by 90° in relation to one another.

19. Container stop mechanism according to claim 1, wherein the first drive unit is configured in such a way that it accelerates the holding arrangement out of the initial position of the jib, first along the acceleration path in the transport direction, before it moves the stopping arrangement, in the stop position of the jib, at a speed which is at least reduced in relation to the transport speed of a transporter.

20. Method for the controlled braking and/or stopping and/or separating of at least one container in a container flow moving in a transport direction on a container transport path, wherein at least one stopping arrangement, configured for the at least partial engagement into the container flow, is driven in a controlled manner by at least one first drive unit along the container transport path in and/or against the transport direction, and wherein the at least one stopping arrangement is moved in a controlled manner by at least one second drive unit between an initial position, not engaging into the container flow, and a stop position engaging into the container flow, wherein a jib, extending along the container transport path, provided at which are at least one holding arrangement as well as the first and second drive units, is pivoted by the second drive unit around a vertical axis between the initial position and the stop position.
